(19) United States
(12) Patent Application Publication
(10) Pub. No.: US 2025/0065699 A1
(43) Pub. Date: Feb. 27, 2025

(54) SUN SHADE VISOR FOR VEHICLES

(71) Applicant: Leoness Aguilar, San Antonio, TX (US)

(72) Inventor: Leoness Aguilar, San Antonio, TX (US)

(21) Appl. No.: 18/814,424

(22) Filed: Aug. 23, 2024

Related U.S. Application Data
(60) Provisional application No. 63/534,551, filed on Aug. 24, 2023.

(51) Int. Cl. B60J 3/02

(52) U.S. Cl. CPC B60J 3/0208

(57) ABSTRACT

A sun shade visor attachment features three semi-transparent, or optically transparent sunshade material panels assembled as a single product. The panels are interconnected, allowing various configurations relative to each other and the existing car visor. The sun shade visor is designed to mount on existing vehicle visors without hindering operation thereof when in a closed position. In one embodiment, the panels can swing out, extend laterally, and/or pull down from the apparatus, providing versatile sun protection.

### CROSS-REFERENCE TO RELATED APPLICATIONS

This application claims priority to U.S. Provisional Patent Application No. 63/534,551 filed on Aug. 24, 2023, entitled “Sun Shade Visor for Vehicles,” the contents of which are incorporated herein by reference.

### BACKGROUND

### Field of the Art

The present disclosure is related to the field of vehicle visors. In particular, the present disclosure relates to a sun shade visor attachment for improving visibility for drivers and passengers.

### Discussion of the State of the Art

In the field of automotive safety, driver visibility is a paramount concern. The ability of a driver to clearly perceive the road, other vehicles, pedestrians, and various obstacles is critical to safe and efficient operation of a vehicle. However, there are several factors that can significantly impair driver visibility. One of the most common is sunlight, particularly during sunrise and sunset hours when the sun is at a low angle and can shine directly into the driver's eyes. This can cause discomfort, temporary blindness, and a significant reduction in the driver's ability to perceive the road and its surroundings.

Another common source of visibility impairment is the headlights of oncoming vehicles, particularly at night. The bright light from these headlights can create a glare that temporarily blinds the driver or significantly reduces their ability to see. This can be particularly dangerous on narrow or winding roads, where the ability to accurately judge distances and perceive obstacles is critical.

Reflections and glare from the vehicle's windshield or other surfaces can also significantly impair driver visibility. These reflections can be caused by a variety of sources, including the sun, oncoming headlights, streetlights, and even the vehicle's own dashboard. These reflections can create a confusing and distracting visual environment that can significantly reduce the driver's ability to focus on the road.

To mitigate these issues, car manufacturers have traditionally installed sun visors in their vehicles. These visors are typically located on the interior of the vehicle, just above the windshield. When the sun is shining directly into the windshield, the driver or front passenger can flip down the visor from its resting position against the roof. This positions the visor between the sun and the driver's or passenger's eyes, blocking a significant amount of the incoming light and reducing glare.

However, while traditional sun visors can be effective at reducing glare and improving visibility in certain situations, they also have significant drawbacks. One of the most significant is that they can also reduce visibility by blocking the driver's line of sight. This can create a potentially dangerous situation, particularly when the driver is navigating through traffic or around obstacles. The driver may not be able to see traffic signals, pedestrians, or other vehicles that are in the area obscured by the visor. This can significantly increase the risk of accidents, particularly in busy urban environments or on crowded highways.

### SUMMARY

The present invention is a sun shade visor attachment that solves the problem of driver visibility impairment caused by sun glare, oncoming headlights, and reflections. The sun shade visor attachment includes three semi-transparent, or optically transparent, sunshade panels assembled as a single product. These panels are interconnected and can be placed in various configurations relative to each other and to an existing visor that comes pre-installed in the vehicle. The sun shade visor attachment is designed to be easily mounted on an existing sun visor in a manner that does not interfere with the operation of the existing sun visor when the visor attachment is in a closed position.

The sun shade visor attachment overcomes the visibility issues associated with conventional sun visors by introducing three semi-transparent, or optically transparent sunshade visor panels that form the inventive apparatus. These include a main body panel, a swing-out panel, and a slide-down panel. The sun shade visor attachment attaches to an existing sun visor of a vehicle, allowing the main body panel to rotate downward from the existing sun visor when the existing sun visor is in a closed position. Notably, the visor attachment is made of lightweight materials and is hingedly coupled to the existing sun visor in a manner that allows the visor attachment to be used separately from the existing sun visor. In other words, the existing sun visor may be in the raised position adjacent to the roof of the vehicle while the sun shade visor attachment is in the lowered position adjacent to the windshield of the vehicle.

The swing-out panel of the attachment swings away from the other panels to cover a portion of the driver or passenger side window. The swing out panel can also slide over the rearview mirror, providing protection in areas that conventional vehicle visor products do not cover, without eliminating the purpose or use of the rearview mirror. The slide-down panel extends from the main body panel to offer additional protection below the area that conventional visor products do not cover.

The sun shade visor attachment of the present invention offers several benefits. It improves driver visibility by reducing glare and reflections without blocking the driver's line of sight. It also provides protection in areas that are not covered by existing vehicle visor products, including the side window, rear view mirror, and the area below the existing sun visor. Additionally, the sun shade visor attachment is designed to work in conjunction with existing vehicle visors, allowing for flexible and customizable configuration based on the driver's needs.

The sun shade visor attachment comprises a main body panel, a swing-out panel, a slide-down panel, a rotation mechanism, an extension mechanism, and a connection mechanism. The inventive design and functionality of the sun shade visor attachment provide an advancement in the field of automotive safety by enhancing driver visibility and reducing the risk of accidents caused by glare and reflections.

In one example, a sun shade visor for a vehicle includes a plurality of panels. Each one of the panels is made of a semi-transparent material, or optically transparent, sunshade panels assembled as a single product. Each one of the panels may be made of plastic. For example, each one of the panels may be made of a transparent thermoplastic (e.g., polycarbonate). The plurality of panels include a main body panel, a swing panel, and a slide-down panel. The sun shade visor further includes a connection mechanism coupled to at least one of the panels. The plurality of panels are configured to rotate relative to a portion of the connection mechanism. Still further, the sun shade visor includes a rotation mechanism and an extension mechanism. The rotation mechanism is coupled to the swing panel and the main body panel, and is configured to enable the swing panel to rotate away from the main body panel to a rotated configuration that is perpendicular to the main body panel. The extension mechanism is coupled to the slide-down panel and the main body panel, and is configured to enable the slide down panel to extend downward relative to the main body panel. A frame may be fixedly coupled to the main body panel. The connection mechanism may be coupled to the frame. The connection mechanism may include clamps coupled to hinges, and the clamps may be configured to clamp onto a pre-installed existing sun visor. The rotation mechanism may include a swing arm rotatably coupled to a pivot housing, and the pivot housing may be fixedly coupled to the frame. The swing panel may be coupled to the swing arm and may be configured to laterally extend relative to the swing arm. The extension mechanism may include grooves or guides coupled to each side of the main body panel and tabs coupled to each side of the slide-down panel. The tabs may fit within the grooves or guides and slide longitudinally relative to the grooves or guides. The connection mechanism may be configured to attach to a pre-installed existing sun visor. The plurality of panels may be configured to rotate relative to the portion of the connection mechanism between a stowed position in which the plurality of panels is adjacent to the pre-installed existing sun visor and a deployed position in which the plurality of panels is substantially perpendicular to the pre-installed existing sun visor.

In another example, a sun shade visor for a vehicle includes a main body panel, a swing panel rotatably coupled to the main body panel, and a slide down panel coupled to the main body panel and configured to slide up and down relative to the main body panel. The main body panel, the swing panel, and the slide down panel are all made of a transparent material (e.g., polycarbonate) configured to filter out sunlight and glare without reducing a user's visibility. The transparent material may be photochromic. The main body panel, the swing panel, and the slide down panel are approximately the same size as each other. The sun visor has a collapsed configuration in which the main body panel, the swing panel, and the slide down panel are stacked together. The sun visor further has an extended configuration in which the slide down panel is pulled down relative to the main body panel and the swing panel is rotated away from the main body panel to a position that is perpendicular to the main body panel. The sun visor may also include a connection mechanism fixedly attached to the main body panel. The connection mechanism may include a hinge and the main body panel may be configured to rotate relative to a portion of the connection mechanism. The swing panel may be configured to extend laterally relative to the main body panel.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a visor attachment in a down position, in accordance with an embodiment of the present invention.

FIG. 2 illustrates a visor attachment in a laterally and vertically extended down position, in accordance with an embodiment of the present invention.

FIG. 3 illustrates a visor attachment in a collapsed configuration, in accordance with an embodiment of the present invention.

FIG. 4 illustrates a visor attachment in a down position with a swing panel partially rotated, in accordance with an embodiment of the present invention.

FIG. 5 illustrates a visor attachment in a down position with a swing panel fully rotated and fully extended, in accordance with an embodiment of the present invention.

FIG. 6 illustrates a visor attachment in a down position with a swing panel fully rotated and retracted and a slide down panel extended, in accordance with an embodiment of the present invention.

FIG. 7 is an exploded view of a visor attachment, in accordance with an embodiment of the present invention.

FIG. 8 is an exploded view of a visor attachment, in accordance with an embodiment of the present invention.

### DETAILED DESCRIPTION

The present invention is a sun shade visor attachment configured to attach to a pre-installed conventional sun visor of a vehicle. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Apparatus

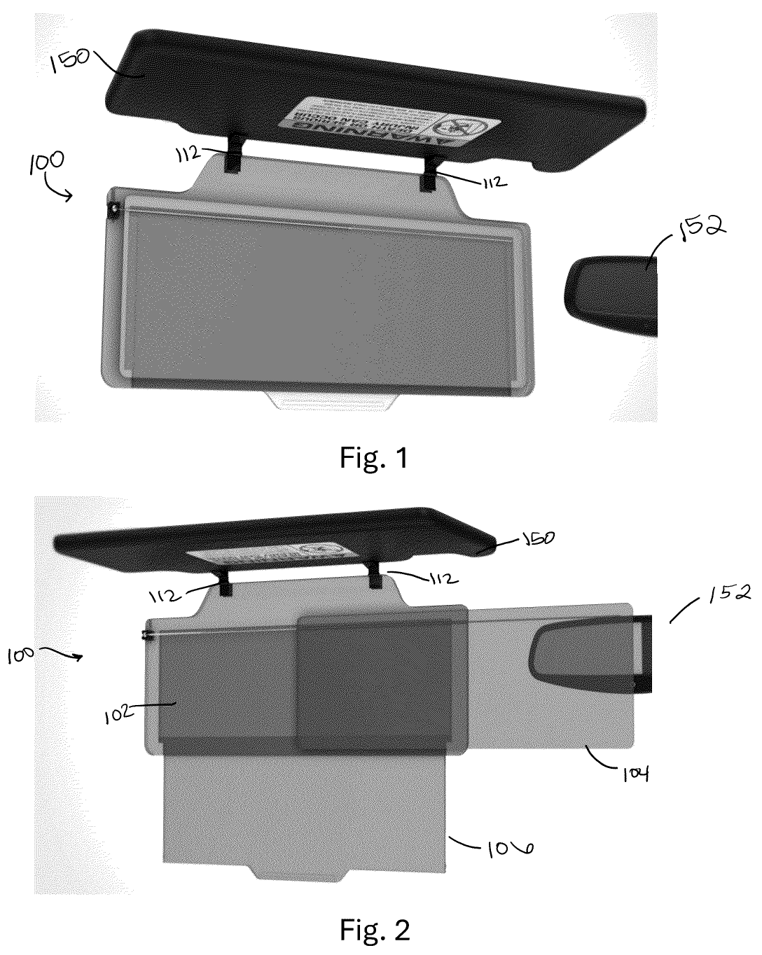

The multi-functional sun shade visor attachment 100 of the present invention is shown in FIGS. 1 and 2 being used in two different configurations. The sun shade visor attachment 100 is coupled to an existing sun visor 150 that is pre-installed in a vehicle. The sun shade visor attachment 100 is shown folded down relative to the existing sun visor 150, but may also be folded up when not in use. In the folded down position, the sun shade visor attachment 100 is positioned between a user's eyes and an oncoming light source or glare. FIGS. 1 and 2 show the existing sun visor 150 in a raised position adjacent to the ceiling of the vehicle while the sun shade visor attachment 100 is in a lowered position adjacent to the windshield of the vehicle.

A hinged connection mechanism 112 (described in greater detail below) is used to attach the sun shade visor attachment 100 to the existing visor 150. The hinged connection mechanism 112 is an advantageous feature of the visor attachment 100 because it allows the visor attachment 100 to be used independently of the existing visor 150. The existing visor 150 does not need to be deployed in order to use the sun shade visor attachment 100. The sun shade visor attachment 100 can be used by itself or in conjunction with the existing visor 150. The hinged connection mechanism 112 also allows the sun shade visor attachment 100 to be quickly and easily installed and uninstalled.

In contrast, conventional visor products are strapped to the existing visor 150 and thus require deployment of the existing visor 150 during use. Conventional visor products are heavy and bulky and thus require the support of being fully strapped to the existing visor 150. Notably, the sun shade visor attachment 100 of the present invention is made of lightweight materials that only require the support of the hinged connection mechanism 112 to hold the sun shade visor attachment 100 in place relative to the existing visor 150.

One of ordinary skill in the art would readily appreciate that the sun shade visor attachment 100 may alternatively be used to replace the existing visor 150. In this exemplary embodiment, the sun shade visor would be fixedly attached to the ceiling of the vehicle rather than clamped on to the existing visor 150 and would include a hinge mechanism so that the visor could be flipped down and back up like a traditional visor.

The sun shade visor attachment 100 includes three panels that can be extended or retracted relative to each other so that the sun shade visor attachment 100 can be used in various configurations, based on the needs of the driver or passenger. Each one of the three panels is made of a lightweight, semi-transparent or optically transparent material. The semi-transparent material of each one of the panels lessens the glaring rays of the sun or of headlights from other vehicles, but does not obscure the user's vision.

When the three panels are in a collapsed configuration, as shown in FIG. 1, a user can still see through the sun shade visor attachment 100 since all three panels are semi-transparent or optically transparent sunshade material. The panels are all approximately the same size as each other. As shown in FIG. 1, when the panels are in the collapsed configuration, the attachment 100 is approximately the same size and shape as the existing visor 150.

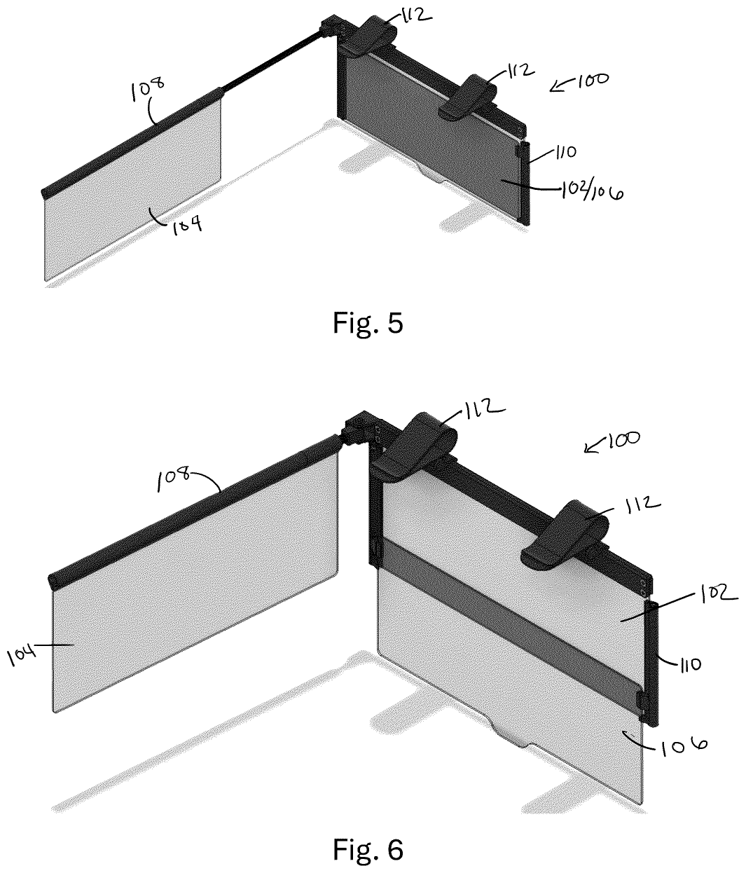

The three panels can be seen more clearly with reference to FIG. 2, which shows the swing panel 104 and the slide down panel 106 in extended configurations relative to the main panel 102. In particular, the swing panel 104 is configured to extend laterally relative to the main panel 102 and is shown extended to the right to cover a portion of the rear view mirror 152. For a visor attachment to be used on the passenger side of the vehicle, the swing panel 104 would extend to the left instead of the right. The swing panel 104 is also configured to swing out relative to the main panel 102, as shown in FIGS. 5 and 6. The slide down panel 106 is configured to extend vertically relative to the main panel 102 and is shown extended downward to cover a lower area of the windshield that is not covered by the existing sun visor 150.

Each one of the panels 102, 104, 106 is made of a semi-transparent or optically transparent sunshade material that a user is able to see through, but that filters out sunlight or glare (such as from headlights of other vehicles). As such, each one of the panels 102, 104, 106 functions as a glare shield that mitigates the negative impact of a light source on a user's visibility, without completely obstructing the user's line of sight. Each one of the panels 102, 104, 106 may be made of polycarbonate or other similar lightweight plastic material. Each one of the panels 102, 104, 106 may be photochromic and/or polarized.

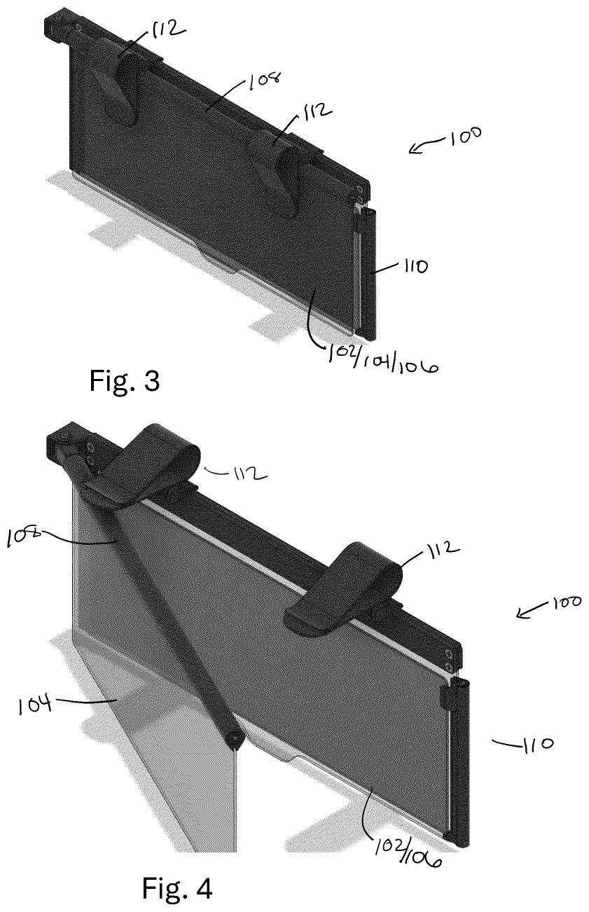

The sun shade visor attachment 100 is depicted in other configurations in FIGS. 3-6. FIG. 3 depicts the sun shade visor attachment 100 in a folded position with all three panels 102, 104, 106 retracted and stacked on top of each other. With all three panels aligned, as shown in FIG. 3, the sun shade visor attachment 100 is approximately the same size and shape as the pre-installed existing sun visor 150. The sun shade visor attachment 100 is depicted in the stowed configuration in FIG. 3 with the hinged connection mechanism 112 being substantially parallel to the panels 102/104/106.

FIG. 4 depicts the panels 102, 104, 106 folded down relative to the hinged connection mechanism 112. That is, the panels 102, 104, 106 are in a position that is substantially perpendicular to the hinged connection mechanism. FIG. 4 further depicts the swing panel 104 in a partially deployed position with the swing panel 104 rotated away from the main panel 102.

FIG. 5 illustrates the swing panel 104 in a fully rotated and extended position. The swing panel 104 is rotated to be substantially perpendicular to the main panel 102 and the slide down panel 106. The swing panel 104 is further extended away from the main panel 102 and the slide down panel 106. In this configuration, the main panel 102 and the slide down panel 106 are adjacent to the front window of the vehicle, and the swing panel 104 is adjacent to the side window of the vehicle.

FIG. 6 depicts the sun shade visor attachment 100 with the swing panel 104 in a fully rotated and retracted position. The swing panel 104 is rotated away from the main panel 102 in a position that is substantially perpendicular to the main panel 102, and the swing panel 104 is retracted back from the extended position shown in FIG. 5. FIG. 6 further shows the slide down panel 106 in an extended position where the slide down panel 106 is pulled down relative to the main panel 102, thereby covering more area of the windshield.

FIGS. 3-6 also illustrate the swing arm 108 coupled to the swing panel 104 and the extension mechanism 110 coupled to the slide down panel 106. The swing arm 108 connects the swing panel 104 to the main panel 102 and enables the swing panel 104 to rotate and extend away from the main panel 102. The extension mechanism 110 connects the slide down panel 106 to the main panel 102 and enables the slide down panel 106 to slide downward relative to the main panel 102. However, the visor attachment 100 is not limited to the swing arm 108 and the extension mechanism 110 that are illustrated in the drawings. One of ordinary skill in the art would readily appreciate that other mechanisms may alternatively be used to enable the swing panel 104 to rotate away from the main panel 102 and to enable the slide panel 106 to slide down relative to the main panel 102. Such mechanisms may include, but are not limited to, rotating, swiveling, hinging, and folding mechanisms, as would be understood by a person of ordinary skill in the art.

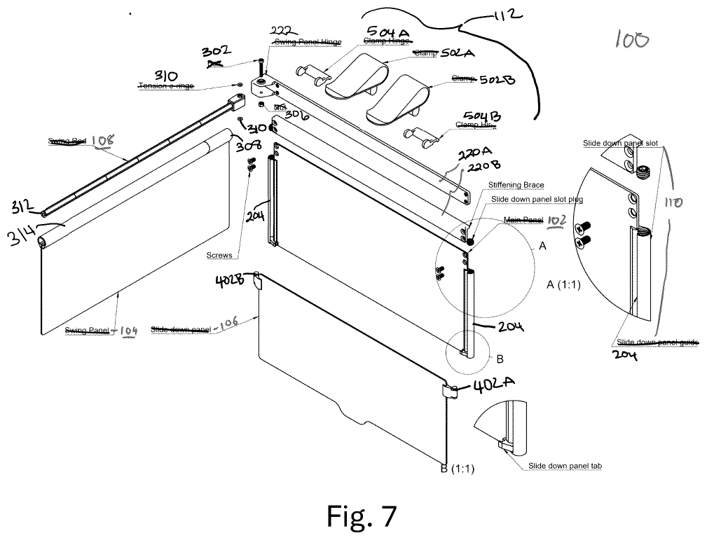

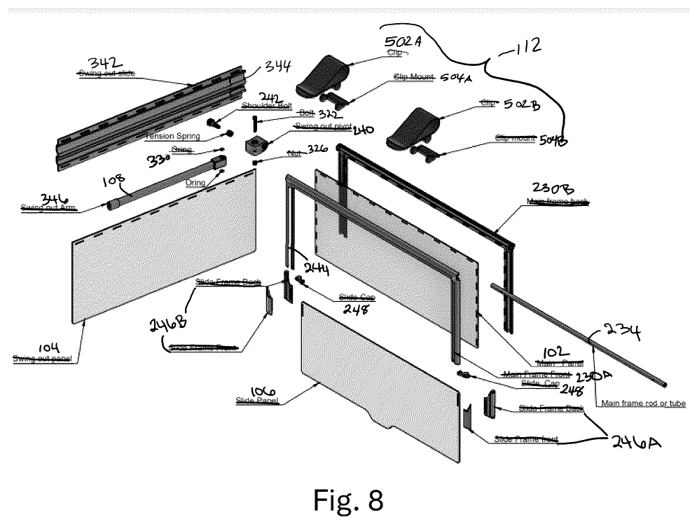

Examples of the construction of the sun shade visor attachment 100 are shown in FIGS. 7 and 8. However, FIGS. 7 and 8 are exemplary only and the visor attachment 100 is not limited to the specific construction depicted in FIGS. 7 and 8.

In a first example of the construction of the sun shade visor attachment, shown in FIG. 7, the main panel 102 is sandwiched between a front top frame 220A and a rear top frame 220B. Attachment mechanisms, such as screws or bolts, are used to couple the top frame 220A, 220B to the top of the main panel 102. One side of the front top frame 220A includes a pivot housing 222 to which the swing panel 104 and the swing arm 108 are coupled.

The swing panel 104 and the swing arm 108 are operatively connected to the main panel 102 through the pivot housing 222, facilitating the rotation of the swing panel 104 into a plane of orientation that is orthogonal to the plane of orientation of the main panel 102 when both the swing panel 104 and the main panel 102 are in an open configuration. This is achieved via a rotating bolt. Specifically, the swing arm 108 is attached to the main panel 102 using a bolt 302 and a nut 306. Tension o-rings 310 may be employed to maintain the functionality of the hinge element over multiple actuations and smooth operation.

In a particular embodiment, the swing panel 104 is designed to slide laterally on the swing arm 108. This feature allows an occupant or user to extend the swing panel 104 further away from the bolt 302, as illustrated in FIG. 5, providing more flexibility in adjusting the sun shade visor attachment 100 to block light or glare from different angles. The swing panel 104 may include a tubular member 314 along the top thereof. The tubular member 314 has an inner diameter that is larger than the outer diameter of the swing arm 108 so that the tubular member 314 is configured to slide laterally back and forth along the swing arm 108 disposed within the tubular member 314. The proximal end 308 of the tubular member 314 and/or the distal end 312 of the swing arm 108 may include a lip or a stopper configured to prevent the swing panel 104 from sliding out or disconnecting from the swing arm 108.

While a rotating element is depicted in FIG. 7, various other mechanisms may be used to enable the swing panel 104 to open in a plane that is perpendicular to that of the main panel 102. Such mechanisms, as would be understood by a person of ordinary skill in the art, may include, but are not limited to, hinges, slides or runners, ball and socket joints, flexures, or magnetic mechanisms, without departing from the scope of the invention. These alternative mechanisms provide additional options for the design and operation of the swing panel 104, allowing for further customization and flexibility in the use of the apparatus.

In one embodiment, the slide down panel 106 is designed to descend from the main panel 102, allowing the sun shade visor attachment 100 to extend further down in front of a vehicle occupant. This feature enables the sun shade visor attachment 100 to provide more coverage than a traditional sun visor, thus offering enhanced protection against sunlight or glare.

The slide down panel 106 descends from the main panel 102 through slide down panel slots 204. The slide tabs 402A and/or 402B fixedly coupled to the slide down panel 106 may be inserted into the slide down panel slots 204 to facilitate the descent of the slide down panel 106. This arrangement provides some friction or resistance against the downward movement of the slide down panel 106 due to gravity or light forces, ensuring a controlled and smooth operation of the panel.

The slide down panel 106 is a semi-transparent, or optically transparent panel, allowing it to mitigate the impact of a light source on an occupant's visibility without completely obstructing the occupant's line of sight. The level of transparency of the slide down panel 106 may vary, as would be understood by a person of ordinary skill in the art, without departing from the scope of the invention. This variability allows for customization of the panel's transparency level based on specific user preferences or lighting conditions.

While slots 204 and tabs 402A, 402B are depicted in FIG. 7 to illustrate the extension mechanism 110, various other extension mechanisms may be used, as would be understood by a person of ordinary skill in the art, without departing from the scope of the invention. These alternative mechanisms provide additional options for the design and operation of the slide down panel 106, allowing for further customization and flexibility in the use of the apparatus.

The attachment mechanism 112 is designed to secure the sun shade visor attachment 100 to a vehicle's sun visor. This design allows users or vehicle occupants to continue using their sun visors in their usual manner, including for storage purposes.

In a particular embodiment, the attachment mechanism 112 includes clamps 502A and/or 502B. These clamps 502A, 502B can be attached directly onto a vehicle's existing sun visor, ensuring a secure and stable connection between the sun visor and the sun shade visor attachment 100.

To connect the clamps 502A and/or 502B to the main panel 102, clamp hinges 504A and/or 504B are employed. The clamps 502A, 502B are coupled to the hinges 504A, 504B using friction fit, nut and bolt, or another similar fastening mechanism that applies minimal pressure to allow for proper rotation of the clamps 502A, 502B relative to the hinges 504A, 504B. The hinges 504A, 504B are fixedly coupled to the upper frame 220A, 220B of the main body panel 102 using adhesive, welding (such as ultrasonic welding or RF welding), or other similar permanent joining methods. These hinges 504A, 504B allow the main panel 102 to swing or hinge down from the vehicle's existing sun visor, thereby providing the flexibility of adjusting the position of the main panel 102 as per the user's needs.

While clamps 502A and/or 502B and clamp hinges 504A and/or 504B have been illustrated as the components of the attachment mechanism 112, other attachment mechanisms may also be employed without deviating from the scope of the invention. A person of ordinary skill in the art would understand that alternatives such as adhesives, screws, nails, bolts, hook and loop closures, straps, snap-fit joints, dovetail joints, and the like could be used in place of or in conjunction with the clamps and hinges described herein.

In a second example of the construction of the sun shade visor attachment 100, shown in FIG. 8, the main panel 102 is sandwiched between a front frame 230A and a back frame 230B. The frame 230A, 230B extends around the sides and top of the main body panel 102, leaving the bottom of the main body panel 102 free for the slide down panel 106 to move up and down relative thereto. Attachment mechanisms, such as screws, bolts, heat fusion, welding (such as ultrasonic welding or RF welding), adhesive, or the like, are used to couple the front and back portions of the frame 230A, 230B to the top and sides of the main panel 102. The frame 230A, 230B further includes a rod 234 sandwiched between the top portions of the front and back halves of the frame. The front frame 230A is secured to the back frame 230B with the rod 234 disposed therebetween along the top portion of the frame 230A, 230B. One side of the top of the main frame 230A, 230B is configured to connect to a pivot housing 240. In particular, a bolt 242 may be used to connect the pivot housing 240 to one end of the rod 234 at the top of the frame 230A, 230B.

The swing panel 104 and the swing arm 108 are operatively connected to the main panel 102 through the pivot housing 240, facilitating the rotation of the swing panel 104 into a plane of orientation that is orthogonal to the plane of orientation of the main panel 102 when both the swing panel 104 and the main panel 102 are in an open configuration. This is achieved via a rotating bolt. Specifically, the swing arm 108 is attached to the pivot housing 240 using a bolt 322 and a nut 326. A tension o-ring 330 may be employed to maintain the functionality of the hinge element over multiple actuations and smooth operation.

In a particular embodiment, the swing panel 104 is designed to slide laterally on the swing arm 108. This feature allows an occupant or user to extend the swing panel 104 further away from the main body panel 102, as illustrated in FIG. 5, providing more flexibility in adjusting the sun shade visor attachment 100 to block light or glare from different angles. The swing panel 104 may be fixedly attached to a swing out slide 342 that is coupled to the swing arm 108. The swing out slide 342 is configured to slide laterally back and forth along the swing arm 108. The proximal end 344 of the swing out slide 342 and/or the distal end 346 of the swing arm 108 may include a lip or a stopper to prevent the swing panel 104 from sliding out or disconnecting from the swing arm 108.

While a rotating element is depicted in FIG. 8, various other mechanisms may be used to enable the swing panel 104 to open in a plane that is perpendicular to that of the main panel 102. Such mechanisms, as would be understood by a person of ordinary skill in the art, may include, but are not limited to, hinges, slides or runners, ball and socket joints, flexures, or magnetic mechanisms, without departing from the scope of the invention. These alternative mechanisms provide additional options for the design and operation of the swing panel 104, allowing for further customization and flexibility in the use of the apparatus.

In one embodiment, the slide down panel 106 is designed to descend from the main panel 102, allowing the visor attachment 100 to extend further down in front of a vehicle occupant. This feature enables the sun shade visor attachment 100 to provide more coverage than a traditional sun visor, thus offering enhanced protection against sunlight or glare.

The slide down panel 106 descends from the main panel 102 through slide down panel slots 244 in the sides of the front frame 230A. Slide tabs 246A and/or 246B fixedly coupled to the sides of the slide down panel 106 may be inserted into the slide down panel slots 244 to facilitate the descent of the slide down panel 106. This arrangement provides some friction or resistance against the downward movement of the slide down panel 106 due to gravity or light forces, ensuring a controlled and smooth operation of the panel.

The slide tabs 246A, 246B are provided in two pieces. During manufacturing, the two pieces of the slide tabs 246A, 246B are fixedly coupled together with the slide down panel 106 sandwiched therebetween. The assembled slide tabs 246A, 246B and slide down panel 106 are then connected to the main body panel 102 with the slide tabs 246A, 246B positioned in the slots 244 in the frame 230A, 230B. The slide tabs 246A, 246B are configured to move up and down within the slots 244 and are prevented from sliding out of the slots 244 by affixing slide caps 248 to the open ends of the frame 230A, 230B.

The slide down panel 106 is a semi-transparent, or optically transparent sunshade material panel, allowing it to mitigate the impact of a light source on an occupant's visibility without completely obstructing the occupant's line of sight. The level of transparency of the slide down panel 106 may vary, as would be understood by a person of ordinary skill in the art, without departing from the scope of the invention. This variability allows for customization of the panel's transparency level based on specific user preferences or lighting conditions.

While slots 244 and tabs 246A, 246B are depicted in FIG. 8 to illustrate the extension mechanism 110, various other extension mechanisms may be used, as would be understood by a person of ordinary skill in the art, without departing from the scope of the invention. These alternative mechanisms provide additional options for the design and operation of the slide down panel 106, allowing for further customization and flexibility in the use of the visor attachment 100.

The attachment mechanism 112 is designed to secure the sun shade visor attachment 100 to a vehicle's existing sun visor. This design allows users or vehicle occupants to continue using their sun visors in their usual manner, including for storage purposes.

In a particular embodiment, the attachment mechanism 112 includes clamps 502A and/or 502B. These clamps 502A, 502B can be attached directly onto a vehicle's sun visor, ensuring a secure and stable connection between the sun visor and the sun shade visor attachment 100.

To connect the clamps 502A and/or 502B to the main panel 102, clamp hinges 504A and/or 504B are employed. The clamps 502A, 502B are coupled to the hinges 504A, 504B using friction fit, nut and bolt, or another similar fastening mechanism that applies minimal pressure to allow for proper rotation of the clamps 502A, 502B relative to the hinges 504A, 504B. The hinges 504A, 504B are fixedly coupled to the top portion of the frame 230A, 230B of the main body panel 102 using adhesive, welding (such as ultrasonic welding or RF welding), or other similar permanent joining methods. These hinges 504A, 504B allow the main panel 102 to swing or hinge down from the vehicle's sun visor, thereby providing the flexibility of adjusting the position of the main panel 102 as per the user's needs.

While clamps 502A and/or 502B and clamp hinges 504A and/or 504B have been illustrated as the components of the attachment mechanism 112, other attachment mechanisms may also be employed without deviating from the scope of the invention. A person of ordinary skill in the art would understand that alternatives such as adhesives, screws, nails, bolts, hook and loop closures, straps, snap-fit joints, dovetail joints, and the like could be used in place of or in conjunction with the clamps and hinges described herein.

In one embodiment the sun shade visor attachment 100 is integrated into a vehicle. In other words, the sun shade visor attachment 100 may replace the existing sun visors that are currently integrated into vehicles of various types.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A sun shade visor for a vehicle, the sun shade visor comprising:
a plurality of panels, each one of the panels being made of a semi-transparent, or optically transparent sunshade material, wherein the plurality of panels comprises: a main body panel, a swing panel, and a slide-down panel;
a connection mechanism coupled to at least one of the panels, wherein the plurality of panels are configured to rotate relative to a portion of the connection mechanism;
a rotation mechanism coupled to the swing panel and the main body panel, the rotation mechanism configured to enable the swing panel to rotate away from the main body panel to a rotated configuration that is perpendicular to the main body panel; and
an extension mechanism coupled to the slide-down panel and the main body panel, the extension mechanism configured to enable the slide down panel to extend downward relative to the main body panel.

2. The sun shade visor attachment of claim 1, further comprising a frame fixedly coupled to the main body panel.

3. The sun shade visor attachment of claim 2, wherein the connection mechanism is coupled to the frame.

4. The sun shade visor attachment of claim 1, wherein the connection mechanism comprises clamps coupled to hinges, wherein the clamps are configured to clamp onto a pre-installed existing sun visor.

5. The sun shade visor attachment of claim 2, wherein the rotation mechanism comprises a swing arm rotatably coupled to a pivot housing, wherein the pivot housing is fixedly coupled to the frame.

6. The sun shade visor attachment of claim 5, wherein the swing panel is coupled to the swing arm and is configured to laterally extend relative to the swing arm.

7. The sun shade visor attachment of claim 1, wherein the extension mechanism comprises grooves or guides coupled to each side of the main body panel and tabs coupled to each side of the slide-down panel, wherein the tabs fit within the grooves or guides and slide longitudinally relative to the grooves or guides.

8. The sun shade visor of claim 1, wherein the connection mechanism is configured to attach to a pre-installed existing sun visor.

9. The sun shade visor of claim 8, wherein the plurality of panels is configured to rotate relative to the portion of the connection mechanism between a stowed position in which the plurality of panels is adjacent to the pre-installed existing sun visor and a deployed position in which the plurality of panels is substantially perpendicular to the pre-installed existing sun visor.

10. The sun shade visor of claim 1, wherein each one of the panels is made of plastic.

11. The sun shade visor of claim 10, wherein the plastic is a transparent thermoplastic.

12. The sun shade visor of claim 11, wherein the transparent thermoplastic is polycarbonate.

13. A sun shade visor for a vehicle, the sun visor comprising:
a main body panel;
a swing panel rotatably coupled to the main body panel; and
a slide down panel coupled to the main body panel and configured to slide up and down relative to the main body panel,
wherein the main body panel, the swing panel, and the slide down panel are all made of a semi-transparent, or optically transparent sunshade material configured to filter out sunlight and glare without reducing a user's visibility,
wherein the main body panel, the swing panel, and the slide down panel are approximately the same size as each other,
wherein sun shade visor has a collapsed configuration in which the main body panel, the swing panel, and the slide down panel are stacked together, and
wherein the sun shade visor has an extended configuration in which the slide down panel is pulled down relative to the main body panel and the swing panel is rotated away from the main body panel to a position that is perpendicular to the main body panel.

14. The sun shade visor of claim 13, further comprising a connection mechanism fixedly attached to the main body panel, wherein the connection mechanism comprises a hinge and the main body panel is configured to rotate relative to a portion of the connection mechanism.

15. The sun shade visor of claim 13, wherein the transparent material is polycarbonate.

16. The sun shade visor of claim 13, wherein the transparent material is photochromic.

17. The sun shade visor of claim 13, wherein the swing panel is further configured to extend laterally relative to the main body panel.
